(19) United States
(12) Patent Application Publication
(10) Pub. No.: US 2009/0010028 A1
(43) Pub. Date: Jan. 8, 2009

(54) INDUCTIVE POWER SUPPLY, REMOTE DEVICE POWERED BY INDUCTIVE POWER SUPPLY AND METHOD FOR OPERATING SAME

(75) Inventors: David W. Baarman, Fennville, MI (US); Nathan P. Stien, Pekin, IL (US); Wesley J. Bachman, Auburn, IL (US); John J. Lord, Springfield, IL (US)

Correspondence Address: WARNER, NORCROSS & JUDD;IN RE: ALTICOR INC., INTELLECTUAL PROPERTY GROUP, 111 LYON STREET, N. W. STE 900, GRAND RAPIDS, MI, 49503-2489, US

(73) Assignee: ACCESS BUSINESS GROUP INTERNATIONAL LLC, Ada, MI (US)

(21) Appl. No.: 12/212,217

(22) Filed: Sep. 25, 2008

Related U.S. Application Data
(62) Division of application No. 11/204,820, filed on Aug. 16, 2005.

(51) Int. Cl. H02M 3/335

(52) U.S. Cl. 363/25

(57) ABSTRACT

An inductive power supply includes a transceiver for sending information between the remote device and the inductive power supply. The remote device determines the actual voltage and then sends a command to the inductive power supply to change the operating frequency if the actual voltage is different from the desired voltage. In order to determine the actual voltage, the remote device determines a peak voltage and then applies a correction factor.

### BACKGROUND OF THE INVENTION

The invention relates to inductive power supplies, and more specifically to a configuration for inductively powering a load based on the power requirement of that load.

Inductively powered remote devices are very convenient. An inductive power supply provides power to a device without direct physical connection. In those devices using inductive power, the device and the inductive power supply are typically designed so that the device works only with one particular type of inductive power supply. This requires that each device have a uniquely designed inductive power supply.

It would be preferable to have an inductive power supply capable of supplying power to a number of different devices.

### SUMMARY OF THE INVENTION

The foregoing deficiencies and other problems presented by conventional inductive charging are resolved by the inductive charging system and method of the present invention.

According to one embodiment, an inductive power supply is comprised of a switch operating at a frequency, a primary energized by the switch, a primary transceiver for receiving frequency change information from a remote device; and a controller for changing the frequency in response to the frequency change information.

According to a second embodiment, a remote device capable of energization by an inductive power supply is comprised of a secondary, a load, a secondary controller for determining the actual voltage across the load; and a secondary transceiver for sending frequency adjustment instructions to the inductive power supply.

According to yet another embodiment, a method of operating an inductive power supply is comprised of energizing a primary at an initial frequency, polling a remote device; and if there is no response from the remote device, turning off the primary.

According to yet another embodiment, a method of operating a remote device, the remote device having a secondary for receiving power at an operating frequency from an inductive power supply and powering a load, is comprised of comparing a desired voltage with an actual voltage; and sending an instruction to the inductive power supply to correct the actual voltage.

### BRIEF DESCRIPTION OF THE DRAWINGS

FIG. 1 shows a system for inductively powering a remote device.

FIG. 2 is a look-up table for use by the system.

FIG. 3 is a flow chart for the operation of secondary controller.

FIG. 4 is a flow chart for the operation of a primary controller.

### DETAILED DESCRIPTION OF THE DRAWINGS

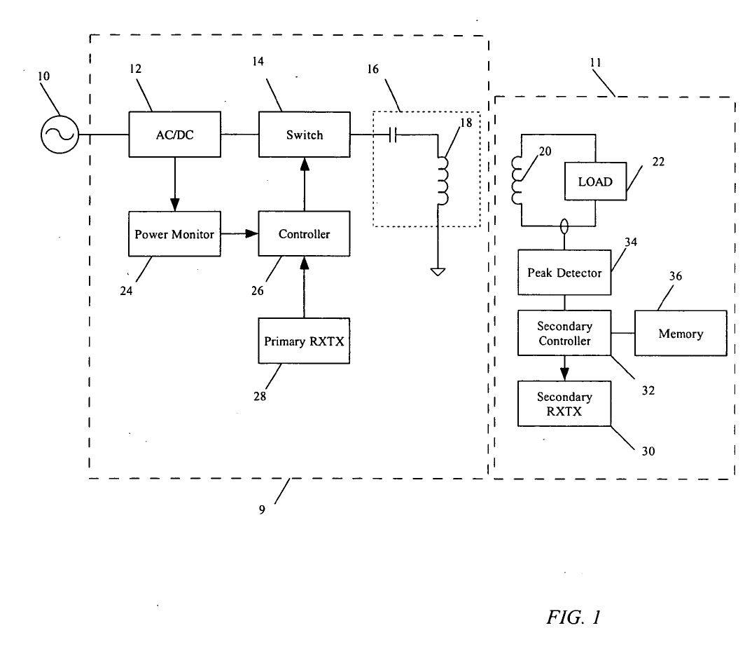

FIG. 1 shows a system for inductively powering a remote device. AC (alternating current) power supply 10 provides power to inductive power supply 9. DC (direct current) power supply 12 converts AC power to DC power. Switch 14 in turn operates to convert the DC power to AC power. The AC power provided by switch 14 then powers tank circuit 16.

Switch 14 could be any one of many types of switch circuits, such as a half-bridge inverter, a full-bridge inverter, or any other single transistor, two transistor or four transistor switching circuits. Tank circuit 16 is shown as a series resonant tank circuit, but a parallel resonant tank circuit could also be used. Tank circuit 16 includes primary 18. Primary 18 energizes secondary 20, thereby supplying power to load 22. Primary 18 is preferably air-core or coreless.

Power monitor 24 senses the voltage and current provided by DC power supply 12 to switch 14. The output of power monitor 24 is provided to primary controller 26. Primary controller 26 controls the operation of switch 14 as well as other devices. Primary controller 26 can adjust the operating frequency of switch 14 so that switch 14 can operate over a range of frequencies. Primary transceiver 28 is a communication device for receiving data communication from secondary transceiver 30. Secondary controller 32 senses the voltage and current provided to load 22.

Primary transceiver 28 could be any of a myriad of wireless communication devices. It could also have more than one mode of operation so as accommodate different secondary transceivers. For example, primary transceiver 28 could allow RFID, IR, 802.11(b), 802.11(g), cellular, or Bluetooth communication.

Primary controller 26 performs several different tasks. It periodically polls power monitor 24 to obtain power information. Primary controller 26 also monitors transceiver 28 for communication from secondary transceiver 30. If controller 26 is not receiving communication from secondary transceiver 30, controller 26 periodically enables the operation of switch 14 for a brief period of time in order to provide sufficient power to any secondary to allow secondary transceiver 30 to be energized. If a secondary is drawing power, then controller 26 controls the operation of switch 14 in order to insure efficient power transfer to load 22, as described in more detail below. Controller 26 is also responsible for routing data packets through primary transceiver 28, as discussed in more detail below. According to one embodiment, controller 26 directs switch 14 to provide power at 30-100 kilohertz (kHz). According to this embodiment, Controller 26 is clocked at 36.864 megahertz (MHz) to provide acceptable frequency resolution while also performing the tasks described above.

Power monitor 24 monitors the AC input current and voltage. Power monitor 24 calculates the mean power consumed by the device. It does so by multiplying instantaneous voltage and current samples to approximate the power consumed. Power monitor 24 also calculates RMS (Root Mean Square) voltage and current, current cresting factor and other diagnostic values. Because the current is non-sinusoidal, the effective power consumed generally differs from the apparent power (V^{rms}*I^{rms}).

To increase the accuracy of the power consumption calculation, current samples can be multiplied with values interpolated from the voltage samples. Each voltage/current product is integrated and held for one full AC cycle. It is then divided by the sample rate to obtain the average power over one cycle. After one cycle, the process is repeated.

Power monitor 24 could be a specially designed chip or the power monitor 24 could be a controller with attendant supporting circuitry.

According to the illustrated embodiment, power monitor 24 references its ground with respect to the neutral side of the AC power line, while primary controller 26 and switch 14 reference a ground based on their own power supply circuitry. As a consequence, the serial link between power monitor 24 and primary controller 26 is bidirectionally optoisolated.

Secondary controller 32 is powered by secondary 20. Secondary 20 is preferably air-core or coreless. Secondary controller 32 may have less computational ability than power monitor 24. Secondary controller 32 monitors the voltage and current with reference to secondary 20, and compares the monitored voltage or current with the target voltage or current required by load 22. The target voltage or current is stored in memory 36. Memory 36 is preferably non-volatile so that the information is not lost at power off. Secondary 32 also requests appropriate changes in the operating frequency of switch 14 by primary controller 26 by way of secondary transceiver 30.

Secondary controller 32 monitors waveforms with a frequency of around 40 KHz (kilohertz). Secondary controller 32 could perform the task of monitoring the waveforms in a manner similar to that of power monitor 24. If so, then peak detector 34 would be optional.

Peak detector 34 determines the peak voltage across secondary 24, load 22 or across any other component within remote device 11.

If secondary controller 32 has insufficient computing power to perform instantaneous current and voltage calculations, then a lookup table could be provided in memory 36. The lookup table includes correction factors indexed by the drive frequency and applied to the voltage observed by peak detector 34 to obtain the actual voltage across secondary 20. Memory 36 could be a 128-byte array in an EEPROM memory of 8-bit correction factors. The correction factors are indexed by the frequency of the current. Secondary controller 32 receives the frequency from controller 26 by way of primary RXTX 28. Alternatively, if secondary controller 32 had more computational ability, it could calculate the frequency. Memory 36 also contains the minimum power consumption information for remote device 11.

The correction factors are unique for each load. For example, an MP3 player acting as a remote device would have different correction factors than an inductively powered light or an inductive heater. In order to obtain the correction factors, the remote device would be characterized. Characterization consists of applying an AC voltage and then varying the frequency. The true RMS voltage is then obtained by using a voltmeter or oscilloscope. The true RMS voltage is then compared with the peak voltage in order to obtain the correction factor. The correction factors for each frequency is then stored in memory 36. One type of correction factor found to be suitable is a multiplier. The multiplier is found by dividing the true RMS voltage with the peak voltage.

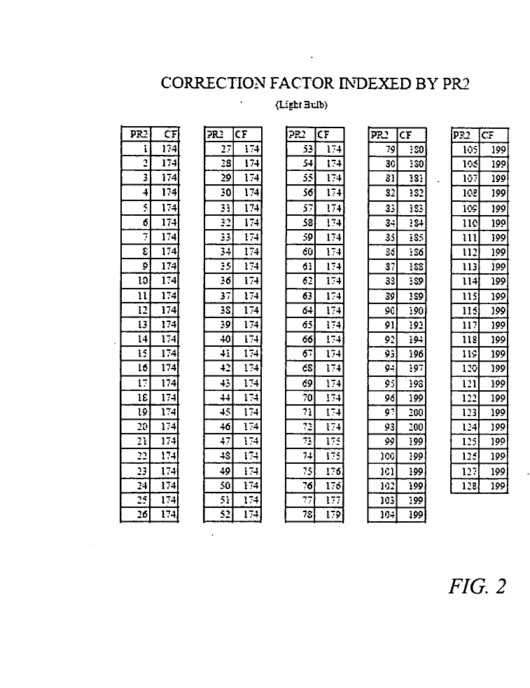

FIG. 2 is a table showing the correction factors for a specific load. When using a PIC18F microcontroller, the PR2 register is used to control the period of the output voltage, and thereby the frequency of the output voltage. The correction factors can range from 0 to 255. The correction factor within the table are 8-bit fixed-point fractions. In order to access the correction factor, the PR2 register for the PIC18F microcontroller is read. The least significant bit is discarded, and that value is then used to retrieve the appropriate correction factor.

It has been found to be effective to match the correction factor with the period. As is well known, the period is the inverse of frequency. Since many microcontrollers such as the PIC18F have a PWM (pulse width modulated) output where the period of the output is dictated by a register, then the lookup table is indexed by the period of the PWM output.

Secondary transceiver 30 could be any of many different types of wireless transceivers, such as an RFID (Radio Frequency Identification), IR (Infra-red), Bluetooth, 802.11(b), 802.11(g), or cellular. If secondary transceiver 30 were an RFID tag, secondary transceiver 30 could be either active or passive in nature.

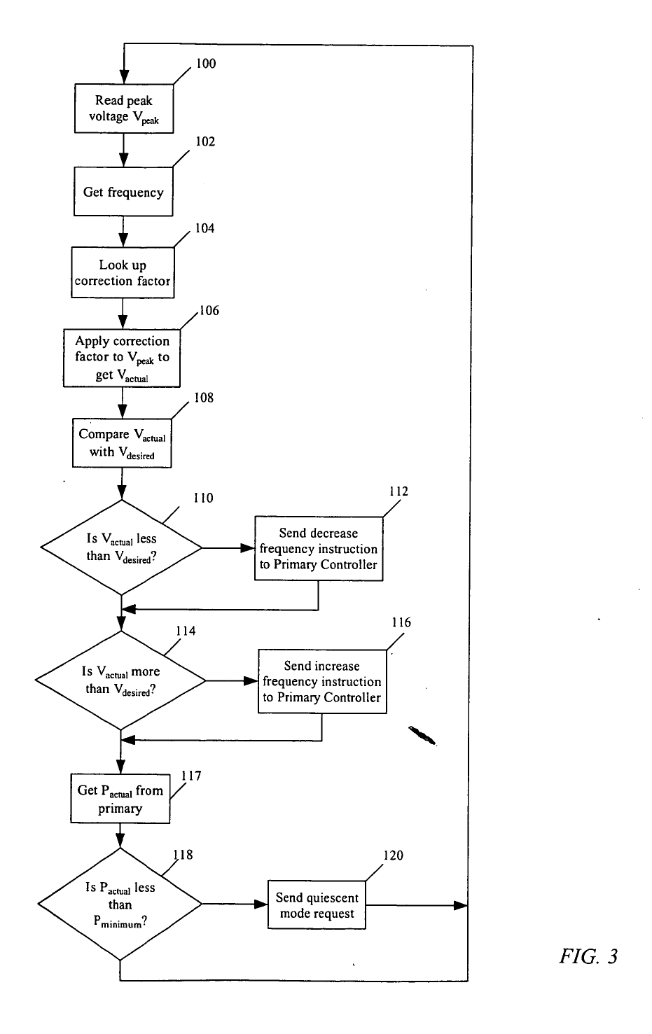

FIG. 3 shows a flow chart for the operation of secondary controller 32. The peak voltage is read by peak detector 34. Step 100. The frequency of the circuit is then obtained by secondary controller 32 either from controller 26 or by computing the frequency itself. Step 102. The frequency is then used to retrieve the correction factor from memory 36. Step 104. The correction factor is then applied to the peak voltage output from peak detector 34 to determine the actual voltage. Step 106.

The actual voltage is compared with the desired voltage stored in memory 36. If the actual voltage is less than a desired voltage, then an instruction is sent to the primary controller to decrease the frequency. Steps 110, 112. If the actual voltage is greater than the desired voltage, then an instruction is sent to the primary controller to increase the frequency. Steps 114, 116.

This change in frequency causes the power output of the circuit to change. If the frequency is decreased so as to move the resonant circuit closer to resonance, then the power output of the circuit is increased. If the frequency is increased, the resonant circuit moves farther from resonance, and thus the output of the circuit is decreased.

Secondary controller 32 then obtains the actual power consumption from primary controller 26. Step 117. If the actual power consumption is less than the minimum power consumption for the load, then controller disables the load and the components enter a quiescent mode. Steps 118, 120.

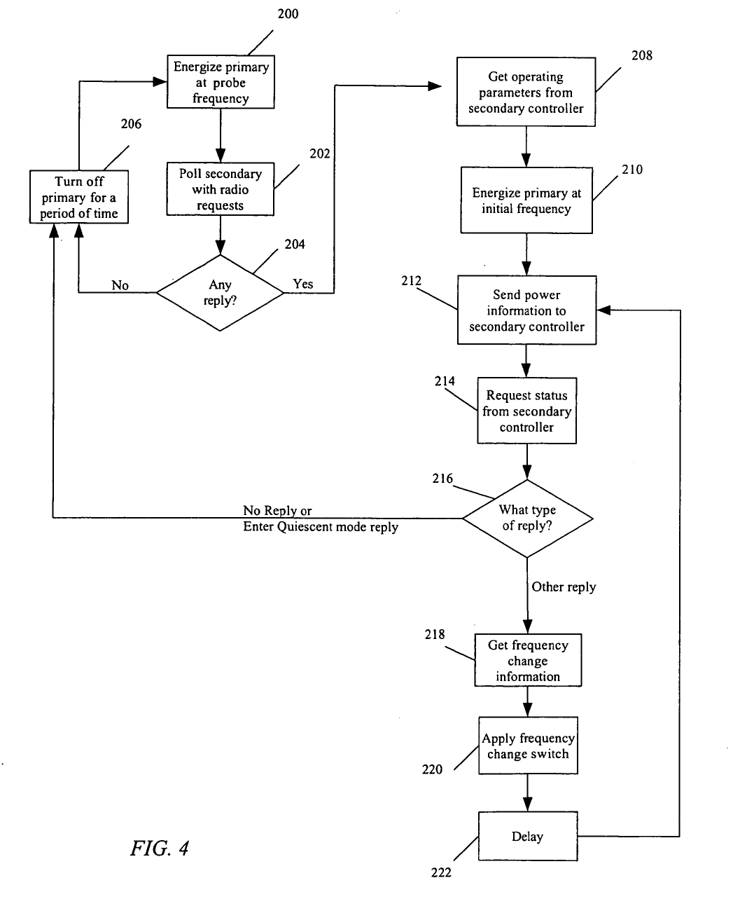

FIG. 4 is a flow chart for operation of primary controller 26. Primary 18 is energized at a probe frequency. Step 200. The probe frequency could be preset or it could be determined based upon any prior communication with a remote device. According to this embodiment, load 32 periodically writes the operating frequency to memory 36. If secondary 20 is de-energized, and subsequently re-energized, secondary controller retrieves the last recorded operating frequency from memory 36 and transmits that operating frequency to primary controller 26 by way of secondary RXTX 30 and primary RXTX 28. The probe frequency should be such that secondary transceiver 30 would be energized.

The secondary transceiver 30 is then polled. Step 202. The system then waits for a reply. Step 204. If no reply is received, then primary 18 is turned off. Step 206. After a predetermined time, the process of polling the remote device occurs again.

If a reply is received from secondary transceiver 30, then the operating parameters are received from secondary controller 32. Step 208. Operating parameters include, but are not limited to initial operating frequency, operating voltage, maximum voltage, and operating current, operating power. Primary controller 26 then enables switch 14 to energize primary 18 at the initial operating frequency. Step 210. Primary controller 26 sends power information to secondary controller 32. Step 212. Primary 18 energizes secondary 20. Primary controller 26 then polls secondary controller 32. Step 214.

If primary controller 26 gets no reply or receives an “enter quiescent mode” command from secondary controller 32, the switch 14 is turned off (step 206), and the process continues from that point.

If primary controller 26 receives a reply, then primary controller 26 extracts any frequency change information from secondary controller 32. Step 218. Primary controller 26 then changes the frequency in accordance with the instruction from secondary controller 32. Step 220. After a delay (step 222), the process repeats by primary controller 26 sending information to secondary controller 32. Step 212.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1.-6. (canceled)

7. A remote device capable of energization by an inductive power supply comprising:
a secondary;
a load;
a secondary controller for determining the actual voltage across the load; and
a secondary transceiver for sending frequency adjustment instructions to the inductive power supply.

8. The remote device of claim 7 further comprising:
a peak detector.

9. The remote device of claim 8 where the secondary controller determines the actual voltage across the load from a peak detector output.

10. The remote device of claim 9 further comprising:
a memory containing a database, the database having a plurality of values indicative of the actual voltage, the database indexed by the peak detector output.

11. The remote device of claim 10 where the database is also indexed by an operating frequency.

12. The remote device of claim 11 where the memory contains a minimum power consumption.

13. The remote device of claim 12 further comprising a secondary transceiver.

14. The remote device of claim 13 where the secondary transceiver is capable of receiving power consumption information from the inductive power supply and the secondary controller compares the power consumption information with the minimum power consumption.

15. A method of operating an inductive power supply comprising:
energizing a primary at an initial frequency;
polling a remote device; and
if there is no response from the remote device, turning off the primary.

16. The method of operating an inductive supply of claim 15 further comprising:
if there is a response from the remote device, then obtaining an operating frequency from the remote device; and
energizing the primary at the operating frequency.

17. The method of operating an inductive supply of claim 16 further comprising:
receiving frequency change information from the remote device; and
changing the operating frequency based upon the frequency change information.

18. The method of operating an inductive supply of claim 17 further comprising:
receiving from the remote device a quiescent mode instruction; and
turning off the primary in response to the quiescent mode instruction.

19. The method of operating an inductive supply of claim 18 further comprising:
determining a consumed power by the primary; and
transmitting the consumed power to the remote device.

20. A method of operating a remote device, the remote device having a secondary for receiving power at an operating frequency from an inductive power supply and powering a load, comprising:
comparing a desired voltage with an actual voltage; and
sending an instruction to the inductive power supply to correct the actual voltage.

21. The method of operating a remote device of claim 20 where the actual voltage and desired voltage are with reference to a voltage across the secondary.

22. The method of operating a remote device of claim 21 where the instruction is a command to the inductive power supply to change the operating frequency.

23. The method of operating a remote device of claim 22 where the step of comparing a desired voltage with an actual voltage further comprises:
reading a peak voltage.

24. The method of operating a remote device of claim 22 where the step of comparing a desired voltage with an actual voltage further comprises:
retrieving from memory a correction factor; and
applying the correction factor to the peak voltage to obtain the actual voltage.

25. The method of operating a remote device of claim 22 where the step of comparing applying the correction factor comprising multiplying the peak voltage by the correction factor.

26. The method of operating a remote device of claim 23 further comprising:
if the actual voltage is greater than desired voltage, then the command to the inductive power supply includes an instruction to increase the operating frequency.

27. The method of operating a remote device of claim 23 further comprising:
if the actual voltage is less than desired voltage, then the command to the inductive power supply includes an instruction to decrease the operating frequency.
